(19) United States
(12) Patent Application Publication
(10) Pub. No.: US 2026/0097483 A1
(43) Pub. Date: Apr. 9, 2026

(54) AUTONOMOUS MOVEMENT ROBOT

(71) Applicant: SHIMIZU CORPORATION, Tokyo (JP)

(72) Inventors: Shunsuke KIMURA, Tokyo (JP); Kakuya NAITO, Tokyo (JP); Reina YAMAMOTO, Tokyo (JP)

(21) Appl. No.: 19/112,701

(22) PCT Filed: Sep. 5, 2023
(86) PCT No.: PCT/JP2023/032384

§ 371 Date: Mar. 18, 2025

(30) Foreign Application Priority Data
Oct. 7, 2022 (JP) 2022-162162
Oct. 7, 2022 (JP) 2022-162163

(51) Int. Cl. B25J 5/00; A45C 13/00; A45C 13/26; B25J 9/00; B25J 9/16; B25J 13/08

(52) U.S. Cl. CPC B25J 5/007; A45C 13/001; A45C 13/262; B25J 9/0009; B25J 9/1664; B25J 13/085; A45C 2200/00

(57) ABSTRACT

An autonomous movement robot, which assists movement of a user, comprises: a robot body configured to be able to travel in an autonomous traveling mode, in which the robot autonomously travels toward a destination, and a manual traveling mode, in which the traveling state can be manually controlled; and a handle attached to the robot body.

### TECHNICAL FIELD

The present invention relates to an autonomous mobile robot and more specifically relates to an autonomous mobile robot that assists a user to move around.

### BACKGROUND

In recent years, autonomous mobile robots that are able to move to a destination location by using, for example, a sensor incorporated in the robot to recognize a surrounding environment or obtaining positional information of the robot are known. As an example autonomous mobile robot, there is also proposed a robot that guides a user such as a visually handicapped person to a destination to assist the user in moving around. For example, Patent Document 1 discloses a mobile robot system that includes a guiding robot and a remote control, which is provided separately from the guiding robot.

The guiding robot of Patent Document 1 includes an operation input unit having a grip held by the user and a touch panel for setting a destination, and is configured to autonomously travel to the set destination. The system disclosed in Patent Document 1 allows the user, through remote control operation, to set a midway place such as a preregistered rest room while on the intended route to the destination, thereby enabling the guiding robot to stop by that place. Patent Document 2 discloses a suitcase-shaped autonomous mobile robot that assists a user in moving around, the robot including a robot body and a handle that extends from the robot body.

### CITATION LIST

### Patent Literature

Patent Document 1: JP 2017-97538 A
Patent Document 2: JP 2022-76648 A

### SUMMARY

As described above, through the use of an autonomous mobile robot, a visually handicapped person will be able to reach a set destination easily. However, an improvement in ease of operation with reduced erroneous operation to increase usability is an important goal. From this point of view, conventional techniques including those disclosed in Patent Documents 1 and 2 have much room for improvement.

According to an aspect of the present invention, there is provided an autonomous mobile robot for assisting a user in moving around, the autonomous mobile robot comprising a robot body configured to be movable in an autonomous traveling mode, in which it travels autonomously toward a destination and a manual traveling mode, in which a traveling state can be controlled manually; and a handle attached to the robot body. The handle includes a first operation unit for causing the robot body to travel and a second operation unit for switching a mode of the robot body. The first operation unit is provided in a first region of the handle, and the second operation unit is provided in a second region of the handle that faces in a different direction from that in which the first region faces.

According to another aspect of the present invention, there is provided an autonomous mobile robot comprising a robot body having an autonomous traveling function; a handle attached to the robot body, the handle extending in a height direction of the robot body; a sensor configured to detect a magnitude and a direction of force applied to the handle; and a control device configured to control a motion of the robot body based on detection information from the sensor, wherein the sensor is provided at a basal portion of the handle.

An autonomous mobile robot according to the present invention provides an improved ease of operation with reduced erroneous operation, achieving increased usability.

### BRIEF DESCRIPTION OF DRAWINGS

FIG. 1 is a perspective view of an autonomous mobile robot according to an example embodiment.

FIG. 2 is a block diagram illustrating a schematic structure of the autonomous mobile robot.

FIG. 3 illustrates a leading portion of a handle of the autonomous mobile robot as viewed from diagonally above.

FIG. 4 illustrates the leading portion of the handle of the autonomous mobile robot as viewed from diagonally below.

FIG. 5 is a perspective view illustrating the entire handle of the autonomous mobile robot.

FIG. 6 is an illustration of a method of using the autonomous mobile robot.

FIG. 7 is a flowchart of an example process for controlling the autonomous mobile robot.

### DESCRIPTION OF EMBODIMENTS

Referring to the drawings, an embodiment of an autonomous mobile robot according to the present invention will be described in detail below. This embodiment is merely an example, and the present invention is not limited to this embodiment. Any structures composed of selective combinations of elements of multiple embodiments and modifications that will be described below fall within the scope of the present invention.

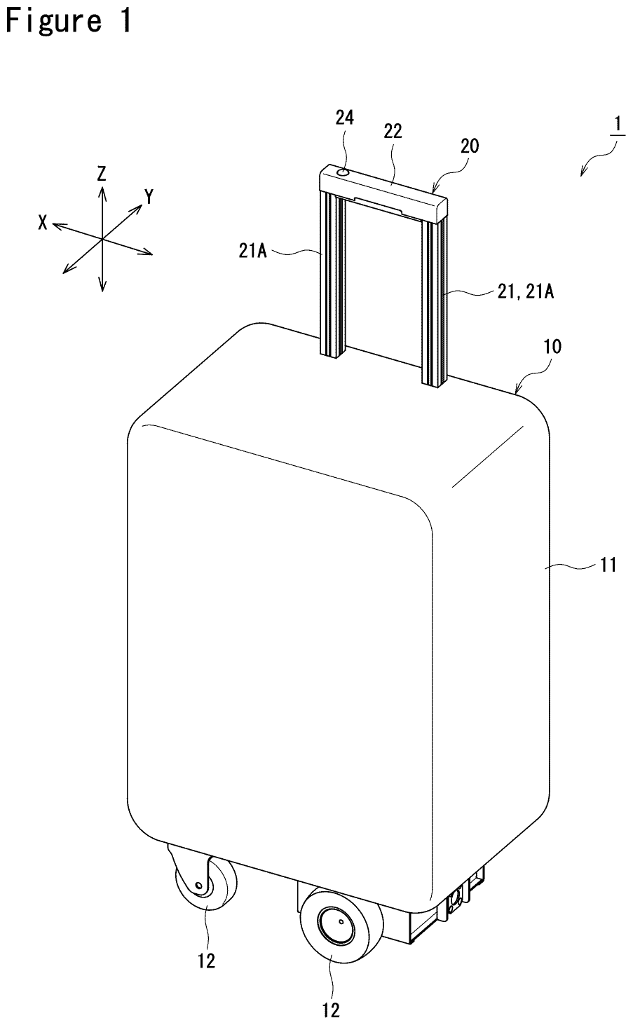

FIG. 1 is a perspective view of an autonomous mobile robot 1 according to an example embodiment of the present invention. As illustrated in FIG. 1, the autonomous mobile robot 1 includes a robot body 10 and a handle 20 attached to the robot body 10. The autonomous mobile robot 1, which is a robot that assists a user in moving around, is able to move to a destination by recognizing a surrounding environment using, for example, a sensor incorporated therein, without a magnetic tape or other guidance means disposed along a route to the destination. The robot body 10 has a function to travel autonomously and is configured to be movable in an autonomous traveling mode, in which it travels autonomously toward a destination, and a manual traveling mode, in which the traveling state can be controlled manually.

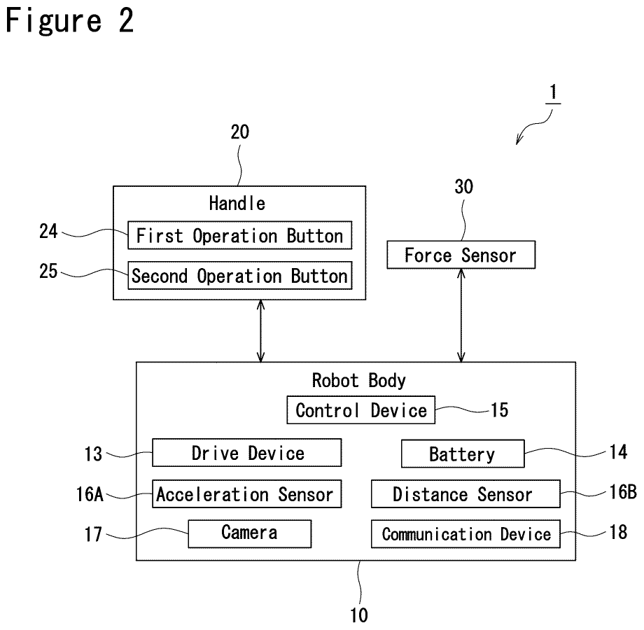

The autonomous mobile robot 1 further includes a force sensor 30 (see, for example, FIG. 2, which will be described below) serving as a sensor configured to detect the magnitude and the direction of force applied to the handle 20. As will be described in detail below, the force sensor 30 is provided at a basal portion of the handle 20. The autonomous mobile robot 1 further includes a control device 15 (see FIG. 2, which will be described below) configured to control the motion of the robot body 10 based on detection information from the force sensor 30. The function of the force sensor 30 provided at the basal portion of the handle 20 allows intuitive operation of the robot based on the natural motion of the user.

The autonomous mobile robot 1 is a mobility assist robot that guides the user to a predetermined destination, and the robot is not supposed to solely travel autonomously. As such, the autonomous mobile robot 1 includes the handle 20 that is to be held by the user. It should be noted that the autonomous mobile robot 1 may be any robot having a navigation function for guiding a user to a destination, and the robot may be capable of solely traveling autonomously. For example, the autonomous mobile robot 1 may solely travel autonomously to a location where the robot is used or where the robot is kept in storage.

The autonomous mobile robot 1 is suitable as a mobility assist robot that guides a visually handicapped person to a destination. The autonomous mobile robot 1 is configured to be easily operated even by a visually handicapped person. It should be noted that the users of the autonomous mobile robot 1 are not limited to visually handicapped people. Even a person without visual handicaps, such as a person who does not know where the destination is located, may be a user of the autonomous mobile robot 1, that is, a person who is guided by the autonomous mobile robot 1 to the destination.

The autonomous mobile robot 1 is used in a particular building. Examples of particular buildings include commercial facilities such as shops and shopping malls, public facilities such as hospitals, airports, stations, city halls, libraries, art museums, and schools, and places of business such as offices, research institutes, and factories. Note that the location where the autonomous mobile robot 1 is used is not limited to particular buildings but may be an outdoor facility such as a park, a zoo, or a theme park. Also, the autonomous mobile robot 1 may be privately owned by, for example, a visually handicapped person, and may be usable at any chosen location.

Through the use of the autonomous mobile robot 1, even a visually handicapped person will be able to reach a set destination easily. However, it is assumed that in some cases, the user may wish to stop by a location away from the intended route, or may wish to change orientation of the robot while moving toward the destination. To meet this need, there is also proposed an autonomous mobile robot that has a manual traveling mode in which the traveling state of the robot can be controlled manually, but usability may be impaired if erroneous switching of operation mode occurs frequently such as, for example, the traveling mode being switched unintentionally due to, for example, erroneous operation by the user. That is, while intended mode switching is easy, erroneous operation should be reduced sufficiently.

The autonomous mobile robot 1 enables reduced erroneous operation while ensuring good ease of operation. With the autonomous mobile robot 1, for example, switching of the traveling mode is easy as the handle 20 has an operation unit for the purpose of switching the operation mode. Also, as this operation unit is disposed on the handle 20 in a region that faces in a different direction from that in which a typically frequently-used traveling-purpose operation unit faces, unintentional mode switching caused by erroneous operation is unlikely to occur.

During a typical use of the autonomous mobile robot 1, the user may, for example, hold the handle 20 and move together with the robot, and such use involves needs for intuitive operation of the robot based on the natural motion of the user. Specifically, accurate detection of the user's action on the robot and effective use of the detection information for controlling the robot are demanded. The autonomous mobile robot 1 can accurately detect force acting on the handle 20 in response to the user's handle operation as a sensor for detecting force applied to the handle 20 is provided at the basal portion of the handle 20. Controlling the robot using the detection information enables more intuitive operation of the robot than operation of the robot using, for example, a button, a switch, or a joystick.

For convenience of description, terms representing directions illustrated in FIG. 1, including a front-and-back direction X, a right-and-left direction Y, and a height direction Z, are used in the present specification. These directions represent directions observed in a typical state of use of the autonomous mobile robot 1. Specifically, the front of the autonomous mobile robot 1 and elements (such as the robot body 10 and the handle 20) of the robot represents a direction of travel in which the robot is moving autonomously. The back of the robot is the opposite direction to the front, and the right-and-left direction Y is a direction perpendicular to the front-and-back direction X and the height direction Z. The height direction Z represents a direction perpendicular to a surface on which the robot is placed, and corresponds to the vertical direction when the robot is placed on a horizontal surface. The autonomous mobile robot 1 is movable backward. That is, the front-and-back direction X is a direction in which the robot moves.

The robot body 10, which is a device unit including various types of devices for achieving an autonomous traveling function, has a housing 11 and wheels 12. The housing 11 is a case that contains the various types of devices, the case forming an outer appearance of the robot body 10. Inside the robot body 10, that is, within the housing 11, devices such as a battery 14 and the control device 15 (see FIG. 2, which will be described below) are provided. The robot body 10 may have, for example, an output device such as a speaker, a camera, and a sensor, which are mounted on the outside of the housing 11.

The robot body 10 includes a drive device 13 (see FIG. 2, which will be described below) and travels by the drive device 13 driving one or more drive wheels of the wheels 12, under control of the control device 15. In this embodiment, four wheels 12 are provided under the housing 11. The housing 11 has a rectangular parallelepiped shape that satisfies a relationship of the length in the height direction Z>the length in the front-and-back direction X>the length in the right-and-left direction Y, but the shape and the size of the housing 11 are not limited to this example. The height of the robot body 10 (length in the height direction Z) is, for example, greater than or equal to 50 cm and less than or equal to 90 cm. Also, for example, the number and the size of the wheels 12 are not particularly limited. Although the robot body 10 may be moved by a means other than wheels, wheels are preferable in terms of, for example, the traveling stability of the robot body 10.

The handle 20 is attached to the robot body 10 and extends in the height direction Z. The handle 20 extends in the height direction Z from, for example, the upper end of the robot body 10. The handle 20 is attached to a central portion in the front-and-back direction in an end portion on the right-hand side as viewed facing toward the direction of travel of the robot body 10. In this case, the user stands on the right-hand side of the robot body 10 and holds the handle 20 with the left hand to operate the autonomous mobile robot 1, thus moving to the destination together with the autonomous mobile robot 1 while holding the handle 20. Note that the handle 20 may be provided in an end portion on the left-hand side of the robot body 10 when the user operates the autonomous mobile robot 1 using the right hand and moves together with the autonomous mobile robot 1 while holding the handle 20. At least a portion of the handle 20 may be attachable and detachable to and from the robot body 10.

The handle 20 includes a first operation button 24 serving as a first operation unit for causing the robot body 10 to travel and a second operation button 25 serving as a second operation unit for switching the mode of the robot body 10 (see, for example, FIG. 2, which will be described below). As will be described in detail below, the first operation button 24 is provided in a first region of the handle 20, and the second operation button 25 is provided in a second region of the handle 20 that faces in a different direction from that in which the first region faces. The handle 20 includes a grip unit 22 that extends in the front-and-back direction X, the grip unit 22 having operation buttons. The grip unit 22 is a grip that is to be held by the user.

While the autonomous mobile robot 1 is a robot that guides the user to the destination, it is assumed that in some cases, the user may wish to stop by a location away from the intended route, or may wish to change orientation of the robot while moving toward the destination. Therefore, the autonomous mobile robot 1 incorporates a manual traveling mode in which the traveling state can be controlled manually. The manual traveling mode is useful when, for example, the user bumps into a friend and wishes to chat, does their shopping, takes a rest sitting on a bench, or wanders freely while moving toward the destination.

The autonomous mobile robot 1 has a destination setting mode for setting a destination of autonomous traveling. After a destination is set by the user in the destination setting mode, the autonomous mobile robot 1 starts traveling autonomously toward the destination in response to a press of the first operation button 24. Note that the user may wish to change the destination after autonomous traveling has been started. Therefore, when the autonomous mobile robot 1 stops from the autonomous traveling state, the operation mode of the robot transitions into the destination setting mode. The user can change the destination by setting a new destination in the destination setting mode. When the autonomous mobile robot 1 stops from the autonomous traveling state, the mode of the robot may be caused to transition into the destination setting mode on the condition that the force sensor 30 detects force acting in the right-and-left direction Y.

The handle 20 further includes a support unit 21 that extends from the robot body 10. The support unit 21 includes one or more arms 21A that extend in the height direction Z. In the illustrated embodiment, two arms 21A are disposed to be spaced apart from each other in the front-and-back direction X. The two arms 21A, each being an elongated rod member, have the same shape and the same length as each other. The grip unit 22 is provided on the leading side of (above) the paired arms 21A, connecting between the paired arms 21A. The grip unit 22 is a rod member having a shorter length than that of the arms 21A, with each of the end portions in the length direction being fixed to a corresponding one of the upper ends of the two arms 21A.

The autonomous mobile robot 1 is a suitcase-shaped mobility assist robot which, as a whole, has a shape similar to a suitcase. As such, the user can handle the autonomous mobile robot 1 feeling like they are walking while pushing a suitcase. However, the autonomous mobile robot according to the present invention is not limited to suitcase-shaped robots.

FIG. 2 is a block diagram illustrating a schematic structure of the autonomous mobile robot 1. As illustrated in FIG. 2, the autonomous mobile robot 1 is configured such that the motion of the robot body 10 can be controlled either based on operation of the first operation button 24 and the second operation button 25 provided on the handle 20, or based on detection information from the force sensor 30. The autonomous mobile robot 1 includes the control device 15 that controls the motion of the robot body 10 based on operation signals from the operation buttons and detection information from the force sensor 30. The operation buttons, the force sensor 30, and various types of sensors, which will be described below, are connected to the control device 15, and operation signals and detection signals are transmitted to the control device 15.

As will be described in detail below, in response to operation of the first operation button 24 in the autonomous traveling mode, the control device 15 causes the robot body 10 to travel autonomously toward the set destination. In response to operation of the second operation button 25 while the robot body 10 is stopped, the control device 15 causes the traveling mode of the robot body 10 to transition into the manual traveling mode. In response to detection of a force applied through the user's handle operation by the force sensor 30, the control device 15 controls the motion of the robot body 10 based on the detection information (detection signal). In the description of the traveling state of the robot, the term “robot body 10” can be read as “autonomous mobile robot 1”. For example, “while the robot body 10 is stopped” is equivalent to “while the autonomous mobile robot 1 is stopped”.

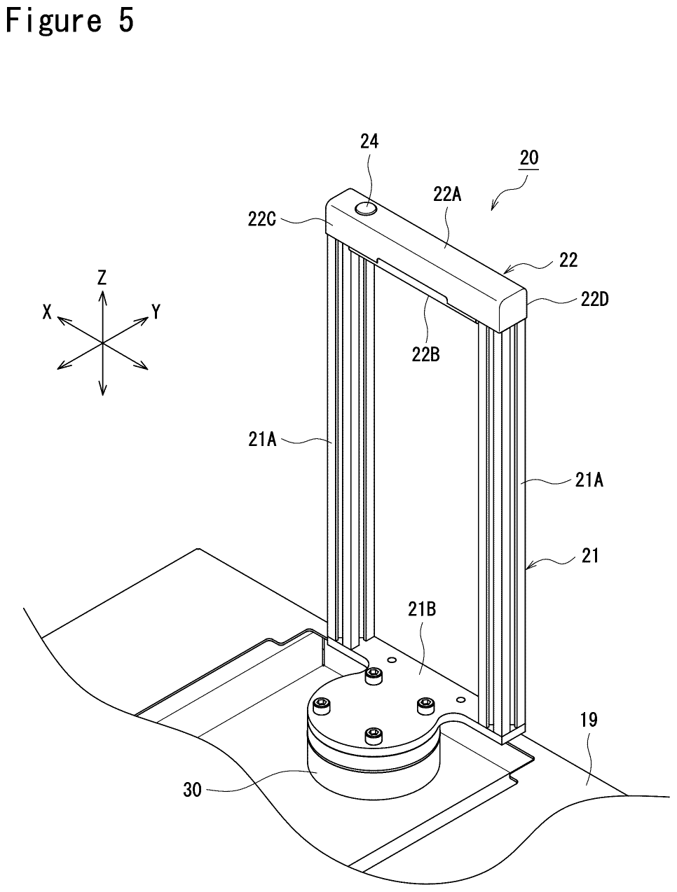

The robot body 10 includes the drive device 13 that drives the wheels 12 and the battery 14 that supplies power to loads which require power. The drive device 13 includes, for example, a motor that drives the wheels 12 in response to supply of power from the battery 14. The drive device 13, the battery 14, and the control device 15 are fixed to, for example, a frame 19 (see FIG. 5, which will be described below) forming a framework of the robot body 10.

The robot body 10 may further include, for example, an acceleration sensor 16A, a distance sensor 16B, a camera 17, and a communication device 18. The acceleration sensor 16A detects, for example, the acceleration, the traveling speed, and the tilt of the autonomous mobile robot 1. For the distance sensor 16B, for example, an optical, ultrasonic, or radio wave distance sensor (range scanner) can be used. Note that the distance sensor 16B, the camera 17, and other components may be provided on the outside of the housing 11.

The control device 15 performs self-location estimation and environment map creation simultaneously using detection information from various types of sensors such as the distance sensor 16B and the camera 17, achieving autonomous traveling of the robot body 10. For autonomous traveling of the robot body 10, conventionally known technology called SLAM (Simultaneous Localization and Mapping) can be used. The control device 15 implements control laws that, for example, simultaneously satisfy both the state restriction that inhibits the distance from an obstacle measured by the distance sensor 16B from becoming less than or equal to a certain distance for avoiding collision with the obstacle, and the acceleration restriction for achieving improved user friendliness.

The control device 15 is composed of a computer including a memory unit that stores, for example, information such as the destination of autonomous traveling, the maximum traveling speed, and the operation mode, and a control program and an arithmetic unit that reads and executes, for example, the control program, thereby controlling the motion of the robot body 10. A candidate destination may be preregistered in the memory unit or may be registrable into the memory unit by the user. The arithmetic unit includes a processor such as a CPU (Central Processing Unit).

Note that the computer that constitutes the control device 15 may have any structure that is capable of controlling the motion of the robot body 10, which is not particularly limited. The control device 15 may receive information such as a GNSS (Global Navigation Satellite System) signal through the function of the communication device 18 and use this information for controlling the autonomous traveling of the robot body 10.

As described above, the autonomous mobile robot 1 includes the force sensor 30 configured to detect the magnitude and the direction of force applied to the handle 20. The control device 15 controls the motion of the robot body 10 based on detection information from the force sensor 30. The control device 15 controls, for example, the traveling state of the robot body 10 in the manual traveling mode based on detection information from the force sensor 30. The function of the force sensor 30 allows the user to operate the robot intuitively. Also, the force sensor 30 may be used to perform setting of, for example, a destination of autonomous traveling.

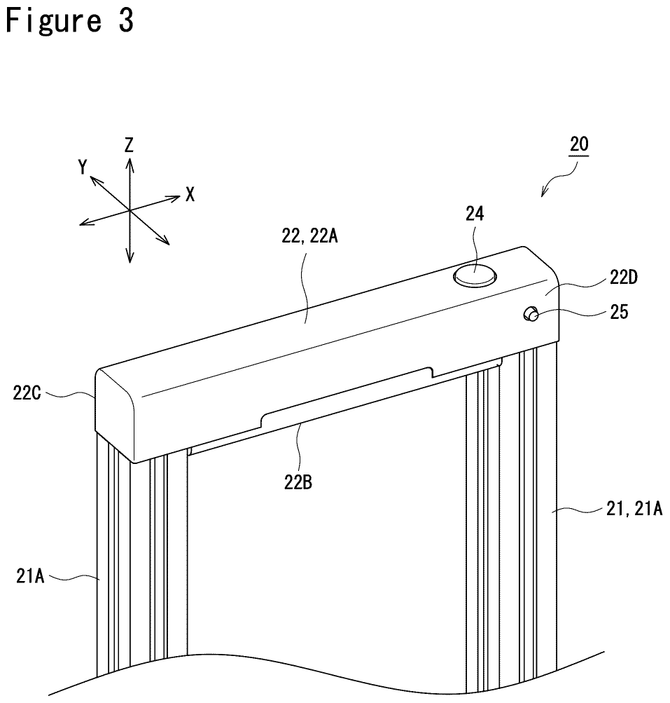

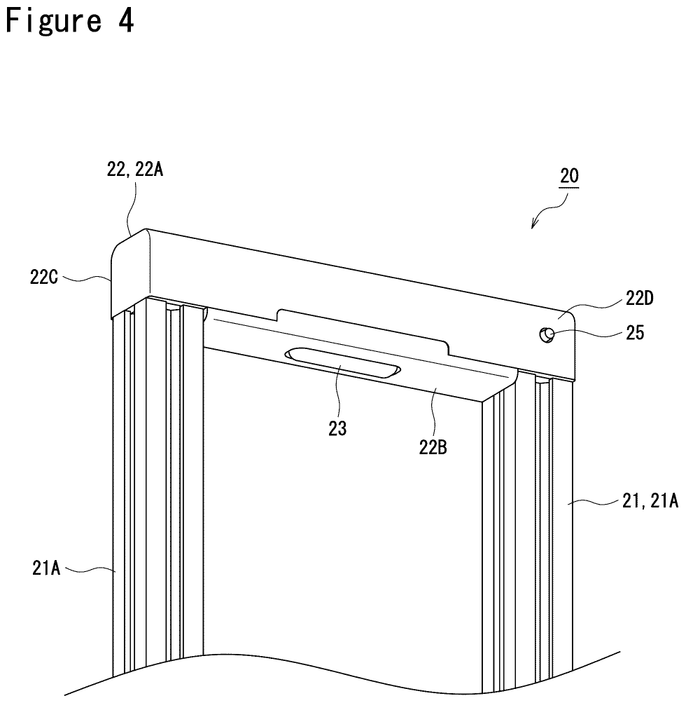

Referring to FIGS. 3 to 5, the handle 20 and the force sensor 30 will be described in further detail below. FIGS. 3 and 4 are enlarged views of the leading portion of the handle 20. FIG. 5 illustrates the handle 20 in its entirety with the housing 11, which covers the basal portion of the handle 20, being removed.

As illustrated in FIGS. 3 to 5, the handle 20 is composed of the support unit 21 including the arms 21A and the grip unit 22 provided on the leading side of the arms 21A. In the illustrated embodiment, the support unit 21 includes a pair of arms 21A and an attachment plate 21B to which basal portions of the pair of arms 21A are fixed. As described above, the pair of arms 21A extend in the height direction Z and are aligned in the front-and-back direction X while being spaced apart from each other in the front-and-back direction X. The grip unit 22 is disposed along the front-and-back direction X so as to connect between the two arms 21A. The handle 20 has an inverted U-shape formed by the two arms 21A and the grip unit 22. Note that the arms 21A and the grip unit 22 may be integral with each other.

The arms 21A have, for example, a length such that the height of the grip unit 22 is approximately at a height between the waist and elbows of the user. In the illustrated embodiment, the pair of arms 21A project from the upper end of the robot body 10 and extend straight in parallel with each other along the height direction Z. The arms 21A have a shape of a rectangular prism having a groove along the height direction Z, but the shape is not particularly limited. The arms 21A may have a retractable structure, or the length extending from the upper end of the robot body 10 may be adjustable. In this case, the length of the arms 21A can be changed in accordance with preferences of the user so that the grip unit 22 is at a height where it is easily operated. Note that the width of the arms 21A (length in the front-and-back direction X) is, for example, greater than or equal to 2 cm and less than or equal to 5 cm.

The grip unit 22 preferably has a length extending straight along the front-and-back direction X and allowing the grip unit 22 to be held without interference with the arms 21A. In other words, the gap between the arms 21A is set so as to avoid interference of a hand with the arms 21A when holding the grip unit 22. A suitable length of the grip unit 22 is, for example, greater than or equal to 12 cm and less than or equal to 20 cm. The cross sectional shape of the grip unit 22 taken in a direction perpendicular to the length direction may be, for example, a perfect circular shape, an elliptical shape, or a semicircular shape, but in the illustrated embodiment, is a quadrangular shape. For ease of holding, the corners of the quadrangular shape are rounded.

The grip unit 22 includes an upper surface 22A that faces upward in the height direction Z, a lower surface 22B that faces downward in the height direction Z, and side surfaces 22C and 22D. When the autonomous mobile robot 1 is placed on a horizontal surface, the upper surface 22A of the grip unit 22 faces vertically upward. The side surfaces 22C and 22D face toward the horizontal direction, the side surface 22C facing toward the left-hand side with respect to the direction of travel, and the side surface 22D facing toward the right-hand side with respect to the direction of travel. The grip unit 22 further includes a side surface (front surface) that faces toward the front of the robot body 10 and a side surface (back surface) that faces toward the back of the robot body 10.

The grip unit 22 may include a vibration rotor 23. The vibration rotor 23 is an output device that is capable of alerting the user to information from the robot by means of vibration. The vibration rotor 23 is used to alert the user to various types of information including, for example, the fact that a destination has been set, the fact that the destination has been reached, and the presence of an obstacle. The handle 20 has the vibration rotor 23 on the lower surface 22B of the grip unit 22. Two or more vibration rotors 23 may be provided, but in the illustrated embodiment, one vibration rotor 23 is provided.

The robot body 10 or the handle 20 may have a different output device such as a speaker that outputs sound. Alternatively, the autonomous mobile robot 1 may include an output device that is separate from the robot body 10 and the handle 20. Examples of separate output devices include earphones and a bone conduction speaker. A smartphone or another terminal device that the user is carrying can also be used as an output device.

As described above, the first operation button 24 and the second operation button 25 are provided on the grip unit 22. In this case, better ease of operation is obtained than could be obtained when the operation units are provided on, for example, the support unit 21, the robot body 10, or a separate remote control. However, random placement of operation buttons may increase the likelihood of erroneous operation such as pushing a wrong button. To avoid this situation, the handle 20 has the first operation button 24 disposed in a first region of the grip unit 22 and the second operation button 25 disposed in a second region of the grip unit 22 that faces in a different direction from that in which the first region faces. This enables reduced erroneous operation effectively while ensuring good ease of operation.

The first operation button 24 may be disposed on the lower surface 22B or a side surface of the grip unit 22, but is preferably disposed on the upper surface 22A of the grip unit 22. The first operation button 24, which is an operation unit used for causing the robot body 10 to travel, is preferably disposed on the easiest-to-operate upper surface 22A, as it is used more frequently and for a longer time than the second operation button 25. On the other hand, the second operation button 25 is preferably disposed on the side surface 22C or the side surface 22D, and in the illustrated embodiment is disposed on the side surface 22D. That is, in the illustrated embodiment, the above-described first region of the handle 20 corresponds to the upper surface 22A of the grip unit 22, and the above-described second region of the handle 20 corresponds to the side surface 22D of the grip unit 22, the operation buttons having operation surfaces oriented at angles that are different from each other by 90°.

Conventionally known push buttons (touch buttons) can be used as the first operation button 24 and the second operation button 25. The following description assumes that the first operation button 24 and the second operation button 25 are push buttons. As such, the first operation button 24 and the second operation button 25 are operated when the first operation button 24 and the second operation button 25 are pushed, and the first operation button 24 and the second operation button 25 are not operated when the first operation button 24 and the second operation button 25 are not pushed. The operation buttons may be any operation units that can be easily operated by the user and that are unlikely to be operated erroneously, and their structures are particularly not limited. The operation buttons may be non-contact buttons that are implemented using, for example, proximity sensors. The shapes of the operation buttons are not particularly limited. Buttons having operation surfaces of circular shapes, as illustrated in FIG. 3, can be used as the operation buttons.

The first operation button 24 is disposed on the upper surface 22A of the grip unit 22 more toward the front of the handle 20 than the center position in the length direction. Preferably, the first operation button 24 is disposed close to the front end position of the grip unit 22 rather than at the center position of the upper surface 22A in the length direction. This facilitates the user in operating the first operation button 24 with a thumb while holding the grip unit 22. The first operation button 24 is, for example, disposed such that a portion of the button overlaps the front-side arm 21A in the height direction Z as viewed in a side view of the autonomous mobile robot 1 (the robot body 10).

The second operation button 25 is disposed on the side surface 22D of the grip unit 22 more toward the front of the handle 20 than the center position of the side surface 22D in the length direction in a similar manner as for the first operation button 24. While the second operation button 25 may be disposed toward the back of the handle 20, disposing it close to the first operation button 24 facilitates even a visually handicapped person in locating the second operation button 25 with a finger (thumb) with which the first operation button 24 is operated, thus increasing the ease of operation. Disposing two operation buttons close to each other causes concerns that erroneous operation may occur, but in the illustrated embodiment, the second operation button 25 is disposed on the side surface 22D, thus sufficiently reducing erroneous operation.

The second operation button 25 is disposed more toward the front end of the grip unit 22 than is the first operation button 24. This structure reduces the possibility of accidentally pushing the second operation button 25 while holding the grip unit 22 compared to a structure wherein the second operation button 25 is disposed more backward than is the first operation button 24, enabling prevention of erroneous operation. The second operation button 25 is, for example, disposed between the front end of the handle 20 and the front end of the first operation button 24 in the front-and-back direction X. That is, the second operation button 25 may be provided at a position that does not overlap the first operation button 24 in the height direction Z as viewed in a side view of the autonomous mobile robot 1.

Further, the second operation button 25 is provided at a position that overlaps the front-side arm 21A in the height direction Z as viewed in a side view of the autonomous mobile robot 1. In other words, the second operation button 25 is provided on an extension line of the front-side arm 21A as viewed in a side view of the autonomous mobile robot 1. In the illustrated embodiment, the second operation button 25 in its entirety overlaps the arm 21A in the height direction Z. The user's hand that is holding the grip unit 22 is typically located between the pair of arms 21A. That is, as the arms 21A interfere with the hand, the hand is unlikely to touch a portion of the side surface 22D that is located more toward the front of the handle 20 than is the back end of the front-side arm 21A. As such, disposing the second operation button 25 in this manner enables more effective reduction in erroneous operation of the second operation button 25.

Preferably, the second operation button 25 is smaller than the first operation button 24. This enables more effective reduction in erroneous operation of the second operation button 25. More specifically, the second operation button 25 preferably has a smaller area of operation surface that is to be touched by a finger of the user than that of the first operation button 24. For operation buttons having operation surfaces having perfect circular shapes, the diameter of the second operation button 25 is preferably less than or equal to 50% of the diameter of the first operation button 24 and is, for example, greater than or equal to 20% and less than or equal to 40% of the diameter of the first operation button 24. The second operation button 25, which is disposed and sized as described above, is more difficult to operate than the first operation button 24.

The handle 20 has only the first operation button 24 and the second operation button 25 as operation units that are to be operated by the user. Although the handle may have third and fourth operation units, having many operation units on the handle complicates operation and causes concerns that erroneous operation may be increased. The handle 20 of the illustrated embodiment can be easily operated even by a visually handicapped person as it has only two operation units provided on the grip unit 22, achieving excellent usability. Additionally, the handle 20 can provide increased commercial value to the autonomous mobile robot 1 from aesthetic aspects, as it has, for example, a simple and stylish design.

As illustrated in FIG. 5, the force sensor 30 is provided at a basal portion of the support unit 21 of the handle 20. Providing the force sensor 30 at the basal portion of the support unit 21 located away from the grip unit 22 facilitates detection of force applied to the handle 20, allowing intuitive operation of the robot based on the natural motion of the user. As the function of the force sensor 30 allows the user to change the direction of travel of the robot as they like by, for example, applying force acting in the right-and-left direction Y to the handle 20 in the manual traveling mode, the user can handle the robot feeling like they are walking while pushing a suitcase.

The force sensor 30 may be a uniaxial force sensor (typically also referred to as load sensor or load cell) that is capable of detecting one-directional force, but is preferably a biaxial force sensor that is capable of detecting force acting in at least the front-and-back direction X and the right-and-left direction Y. The use of a biaxial force sensor also enables detection of force twisting the handle 20. Also, the force sensor 30 may be a triaxial force sensor or a hexaxial force sensor. The detection mechanism of the force sensor 30 is not particularly limited and may be based on a strain gauge, piezoelectric, optical, or electrostatic capacitive method.

The force sensor 30 is fixed to, for example, the frame 19 of the robot body 10 within the housing 11. The support unit 21 penetrates the housing 11 with the basal portion of the support unit 21 and the force sensor 30 being covered by the housing 11. In this structure, the force sensor 30 is protected by the housing 11, and only force applied to the handle 20 is input to the force sensor 30. As described above, the support unit 21 is composed of the pair of arms 21A and the attachment plate 21B. Force applied to the handle 20 is transmitted from the grip unit 22 through the arms 21A and the attachment plate 21B to the force sensor 30.

In the illustrated embodiment, the force sensor 30 is disposed immediately below the attachment plate 21B. Being immediately below the attachment plate 21B herein represents a position that is directly below the attachment plate 21B and proximate to the force sensor 30. The attachment plate 21B may be directly fixed on the force sensor 30, or a thin member that does not substantially attenuate force input to the force sensor 30 may be interposed between the attachment plate 21B and the force sensor 30. For accurate detection of force applied to the handle 20 by the force sensor 30, the arms 21A and the attachment plate 21B are disposed to avoid contact with the housing 11 and the frame 19.

As described above, the control device 15 executes control of the robot body 10 based on detection information from the force sensor 30. When, for example, the traveling mode of the robot body 10 is the manual traveling mode, the control device 15 controls the direction of travel of the robot body 10 or controls the speed of the robot body 10 based on the magnitude and the direction of force applied to the handle 20, which is detected by the force sensor 30. By controlling the motion of the robot body 10 based on detection information from the force sensor 30 provided at the basal portion of the handle 20, the user can operate the robot intuitively.

Further, the control device 15 allows setting of information for causing the robot body 10 to travel, based on the direction of force detected by the force sensor 30. Examples of the information for causing the robot body 10 to travel include the destination of autonomous traveling and the traveling speed of the robot body 10. By allowing, for example, setting of the destination based on detection information from the force sensor 30, that is, the operation of the handle 20 itself, the number of operation units installed on the handle 20 can be reduced, thus achieving simpler operation.

Table 1 lists operation items for the autonomous mobile robot 1 by the first operation button 24, the second operation button 25, and the force sensor 30. The autonomous mobile robot 1 has the autonomous traveling mode, the destination setting mode, and the manual traveling mode. The operation items implemented using the operation buttons and the force sensor 30 differ depending on the operation mode of the robot.

TABLE 1

| | Manual traveling mode | Destination setting mode | Autonomous traveling mode |
|---|---|---|---|
| First operation button | Permit traveling | Determine a destination | Permit traveling |
| | (Translational speed command) | | |
| Second operation button | Transition into the destination | Transition into the manual | No function assigned |
| | setting mode | traveling mode | |
| Force sensor, right or left | Rotational speed command | Select the next or previous | Return to the destination setting |
| (Handle, right or left) | (Make a right or a left turn) | destination | mode |
| Force sensor, front or back | Change the maximum speed | Select a destination category | Change the maximum speed |
| (Handle, front or back) | or move backward | | |

As can be understood from Table 1, the autonomous mobile robot 1 travels only while the first operation button 24 is being operated during the autonomous traveling mode or the manual traveling mode, and stops while the first operation button 24 is not operated. After the autonomous mobile robot 1 stops from the autonomous traveling state upon arrival at the destination, the operation mode of the robot transitions into the destination setting mode in which the destination can be changed. Rather than automatically transitioning into the destination setting mode when the robot stops from the autonomous traveling state upon arrival at the destination, the operation mode of the robot may transition into the destination setting mode on the condition, for example, that the second operation button 25 is operated, or that force acting in the right-and-left direction Y is detected by the force sensor 30.

The control device 15 causes the traveling mode of the robot body 10 to transition into the manual traveling mode in response to operation of the second operation button 25 with the operation mode of the robot being set to the destination setting mode after the autonomous mobile robot 1 stops. Also, the control device 15 causes a transition from the manual traveling mode into the destination setting mode in response to operation of the second operation button 25 while, in the manual traveling mode, the autonomous mobile robot 1 stops, or, that is, the first operation button 24 is not operated. That is, the operation mode of the robot is switched between the destination setting mode and the manual traveling mode in response to operation of the second operation button 25 while the autonomous mobile robot 1 is stopped. Note that operation of the second operation button 25 is invalid while the autonomous mobile robot 1 is traveling.

The destination setting mode is configured to, for example, select a destination from candidate destinations stored in the memory unit of the control device 15, which are grouped into destination lists for each of a building, a building floor, or a facility category, based on output from the force sensor 30 that is capable of detecting force applied to the handle 20. Specifically, in response to detection of force acting the front-and-back direction X by the force sensor 30, a desired destination list is selected from a plurality of destination lists, and in response to detection of force acting the right-and-left direction Y by the force sensor 30, a desired destination is selected from candidate destinations in the selected destination list.

For example, in response to detection of backward acting force by the force sensor 30, the next destination list next to the selected destination list is selected, and in response to detection of frontward acting force by the force sensor 30, the previous destination list previous to the selected destination list is selected. While a desired destination list is being selected, in response to detection of leftward acting force by the force sensor 30, the next item (next destination) in this destination list is selected, and in response to detection of rightward acting force by the force sensor 30, the previous item (previous destination) in this destination list is selected. That is, based on detection information from the force sensor 30, a particular destination is extracted and presented to the user as the destination that is being selected. A destination list or a destination that is being selected is informed to the user using an output device such as a speaker.

To determine the destination, the first operation button 24 can be used. During the destination setting mode, in response to operation of the first operation button 24, the destination that is being selected is set as a new destination. In this structure, to prevent the robot from starting autonomous traveling simultaneously with the setting of the destination, autonomous traveling may be started on the condition, for example, that the button is operated again or, more specifically, that the finger is removed from the first operation button 24 and again operates it, in other words, presses it down. However, with no destination being selected, that is, when, for example, the autonomous mobile robot 1 only stops temporarily from the autonomous traveling state without the operation to change the destination (operation of the handle 20 in the right-and-left direction Y), the robot resumes autonomous traveling in response to operation of the first operation button 24.

In response to operation of the handle 20 in the right-and-left direction Y during traveling in the manual traveling mode, the autonomous mobile robot 1 turns toward the direction in which the force acts. The maximum forward speed of the robot body 10 can be increased or decreased by applying force to the handle 20 in the front-and-back direction X during traveling. During the manual traveling mode, the robot can be caused to move backward in response to application of backward force greater than a predetermined threshold value to the handle 20 while being stopped with the first operation button 24 not operated. These motions based on the operation of the handle 20 can be implemented through the function of the force sensor 30.

During the autonomous traveling mode, the maximum forward speed can be increased or decreased in a similar manner to that in the manual traveling mode by applying force to the handle 20 in the front-and-back direction X with the first operation button 24 being operated, that is, during traveling. However, during the autonomous traveling mode, application of force to the handle 20 in the right-and-left direction Y during traveling cannot cause the robot to turn. That is, operation based on force acting in the right-and-left direction Y detected by the force sensor 30 during traveling is invalid. However, during the autonomous traveling mode, application of force to the handle 20 in the right-and-left direction Y while the autonomous mobile robot 1 is stopped, or more specifically with the first operation button 24 not operated, causes a transition into the destination setting mode. This further enables, in addition to changing the destination, switching to the manual traveling mode. Arrival of the autonomous mobile robot 1 at the destination causes a transition into the destination setting mode. At this time, the control device 15 may prompt the user using an output device such as a speaker to set the next destination.

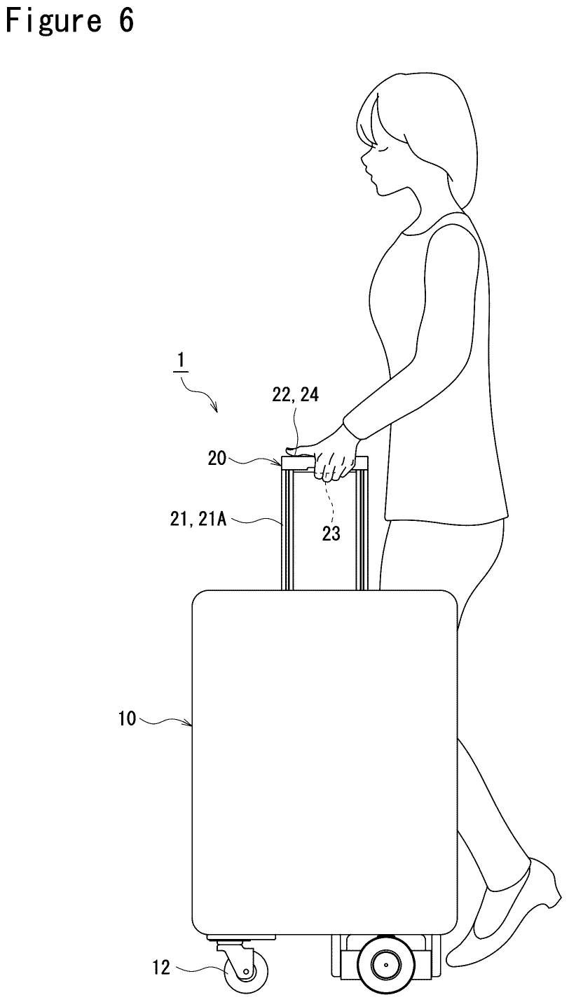

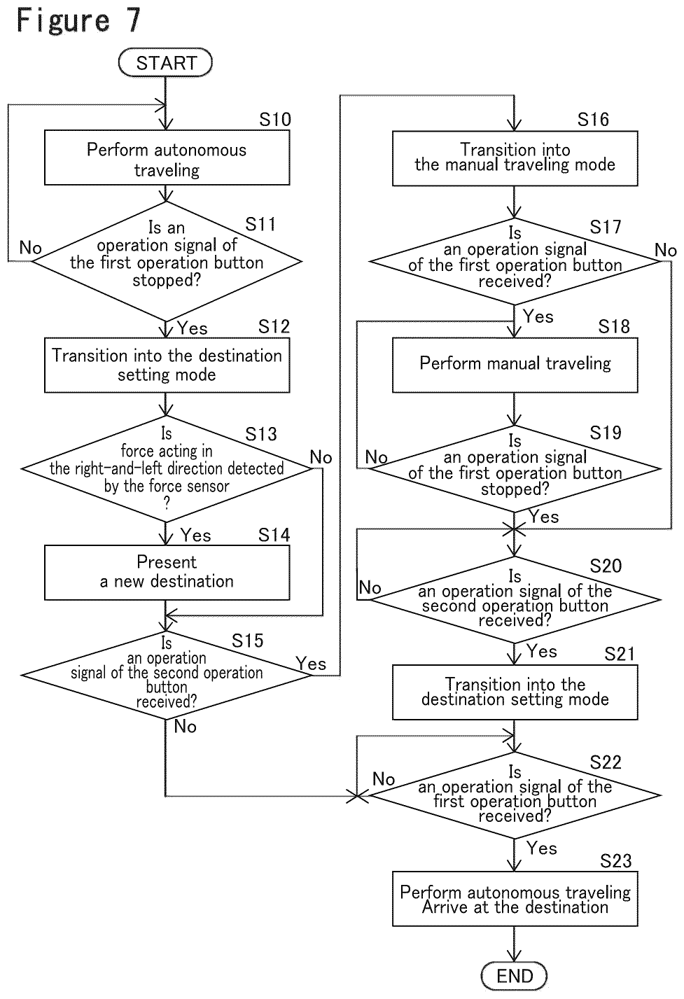

Referring to FIGS. 6 and 7, an example embodiment of use of the autonomous mobile robot 1 having the above-described structure will be described in detail below.

FIG. 6 illustrates the manner in which the user moves together with the autonomous mobile robot 1. As illustrated in FIG. 6, the autonomous mobile robot 1 travels autonomously toward the destination as the user holds the grip unit 22 of the handle 20 and operates the first operation button 24 provided on the upper surface 22A, thereby guiding the user to the destination. As the grip unit 22 extends in the same direction as the direction of travel of the autonomous mobile robot 1, the user is naturally positioned immediately side by side with or diagonally backward and to the right of the robot while the robot is traveling. This structure makes it easier for the user to recognize what the direction of travel of the robot is, than when walking behind the robot, making it less likely to, for example, kick the robot while moving.

As the autonomous mobile robot 1 travels only while the first operation button 24 is being operated, the user can operate the robot to travel or stop at any time. The first operation button 24 is operated by, for example, the thumb of the left hand. As the first operation button 24 is disposed on the upper surface 22A of the grip unit 22 toward the front of the handle 20, the ease of operation is good. At least one of the index finger, the middle finger, the ring finger, and the little finger of the left hand that holds the grip unit 22 is in touch with the vibration rotor 23. During the autonomous traveling mode, information concerning, for example, a change of direction the user will make a few meters later, or a change in floor material, may be communicated to the user by the vibration rotor 23 or sound.

It is possible to handle the autonomous mobile robot 1 feeling like walking while pushing a suitcase. In particular, during the manual traveling mode, the direction of travel of the robot can be changed easily, as, in response to application of force acting in the right-and-left direction Y to the handle 20, the magnitude and the direction of the force are detected by the force sensor 30 provided at the basal portion of the handle 20. Also, the handle 20 can be easily operated even by a visually handicapped person as it has a simple structure with only two operation buttons.

FIG. 7 is a flowchart of an example process for controlling the autonomous mobile robot 1 based on the user's operation. Referring to FIG. 7, an example control process is given in which the autonomous mobile robot 1 stops temporarily from the autonomous traveling state and, after it transitions into the destination setting mode, autonomous traveling is performed again until arrival at the destination. When a destination of autonomous traveling has already been set, in response to operation of the first operation button 24 by the user, the autonomous mobile robot 1 starts traveling autonomously (step S10). In response to reception of an operation signal of the first operation button 24, the control device 15 causes the drive device 13 to drive one or more drive wheels of the wheels 12 to perform autonomous traveling of the robot.

During autonomous traveling of the autonomous mobile robot 1, if the operation of the first operation button 24 is stopped (Yes in step S11), the robot stops and suspends the autonomous traveling, and then the operation mode transitions into the destination setting mode (step S12). If the reception of an operation signal of the first operation button 24 ceases, the control device 15 causes the robot to stop and also causes the operation mode of the robot to transition into the destination setting mode. At this time, a transition may be caused from the autonomous traveling mode into the destination setting mode on the condition that, as the handle 20 is operated in the right-and-left direction Y, the force is detected by the force sensor 30. However, while an operation signal of the first operation button 24 is being received, the autonomous traveling is continued (No in step S11, S10).

During the destination setting mode, if the handle 20 is operated in the right-and-left direction Y and the force is detected by the force sensor 30 (Yes in step S13), a candidate destination is selected as needed from, for example, a destination list, and presented to the user (step S14). During the destination setting mode, in response to detection of force acting in the right-and-left direction Y by the force sensor 30, the control device 15 extracts information concerning a destination preregistered in the memory unit based on the detection information and informs the user of the destination that is being selected using an output device such as a speaker. At this time, in response to operation of the first operation button 24, the destination that is being selected is set as a new destination.

The user may operate the handle 20 in the right-and-left direction Y when they wish to change the destination, thereby selecting a new destination to set, upon operation of the first operation button 24, the destination that is being selected as a new destination. However, if the destination is not changed and switching to the manual traveling mode is not performed (No in step S13, No in S15), the current destination is maintained, and in response to operation of the first operation button 24, autonomous traveling of the robot is resumed (Yes in step S22, S23). Note that if a predetermined period of time has elapsed with a new destination being selected, the state of being selected may be canceled.

During the destination setting mode, in response to operation of the second operation button 25 (Yes in step S15), the traveling mode of the robot body 10 transitions into the manual traveling mode (step S16). In response to reception of an operation signal of the second operation button 25 in the destination setting mode, the control device 15 switches the traveling mode and causes a transition into the manual traveling mode. However, in response to operation of the first operation button 24 with the second operation button 25 not operated, as described above, the autonomous traveling toward the destination is resumed. Note that with none of the operation buttons operated, the destination setting mode is continued.

If the traveling mode of the robot body 10 transitions into the manual traveling mode, in response to operation of the first operation button 24 (Yes in step S17), the autonomous mobile robot 1 starts manual traveling in accordance with the user's handle operation (step S18). In response to reception of an operation signal of the first operation button 24 in the manual traveling mode, the control device 15 causes the robot to move forward and controls, for example, the direction of travel of the robot using detection information from the force sensor 30. In response to detection of rightward acting force by the force sensor 30, the control device 15 causes the robot body 10 to turn to the right, and in response to detection of leftward acting force by the force sensor 30, the control device 15 causes the robot body to turn to the left.

In response to operation of the second operation button 25 (Yes in step S20) while, in the manual traveling mode, the autonomous mobile robot 1 stops, the operation mode 10 transitions into the destination setting mode (step S21). Then, in response to operation of the first operation button 24, the autonomous traveling of the robot is resumed (Yes in step S22, S23). For convenience of description, in the flow in FIG. 7, the robot that has proceeded to step S20 does not again travel manually, but the manual traveling mode is continued until the second operation button 25 is operated. That is, during the manual traveling mode, the control device 15 executes manual traveling each time the first operation button 24 is operated.

As described above, the autonomous mobile robot 1 having the above-described structure enables effective reduction in erroneous operation while ensuring good ease of operation as the grip unit 22 of the handle 20 has the first operation button 24 disposed on the upper surface 22A and the second operation button 25 disposed on the side surface 22D.

In other words, while having the second operation button 25 on the grip unit 22 facilitates switching to the manual traveling mode, erroneous operation of the second operation button 25 is unlikely to occur as the second operation button 25 is provided on the side surface 22D of the grip unit 22. The operation surfaces of the two operation buttons are located proximate to each other but face in directions that are different from each other by 90°. As such, errors such as accidental operation of the second operation button 25 when the first operation button 24 is to be operated are unlikely to occur. While intended switching of the traveling mode is easy, unintentional switching of the traveling mode is effectively reduced.

The user can freely stop by a location away from the intended route by switching from the autonomous traveling mode to the manual traveling mode while on the way toward the destination as guided by the autonomous mobile robot 1. The manual traveling mode provides increased usability as it allows the user, for example, to chat when they bump into a friend, to do their shopping, or to take a rest sitting on a bench while on the way toward the destination. Also, the function of the force sensor 30 provided at the basal portion of the handle 20 provides significantly increased ease of operation of the robot in the manual traveling mode.

The autonomous mobile robot 1, in which detection information from the force sensor 30 is used to control the robot, enables more intuitive operation of the robot than operation of the robot using, for example, a button, a switch, or a joystick. Additionally, as the force sensor 30 can be used to set a destination or other information for causing the robot to travel, the operation units provided on the handle 20 are only the above-described two operation buttons. Therefore, it can be easily operated even by a visually handicapped person. In other words, the autonomous mobile robot 1 has excellent accessibility for visually handicapped people as its operation does not require any particular visual information.

Note that, other than the above-described modifications, the structure of the autonomous mobile robot 1 can include any desired design changes without departing from the purposes of the present invention.

In the above-described embodiment, the control device 15 including the memory unit is provided in the robot body 10, but, for example, a memory unit storing user data such as destination information for autonomous traveling may be provided in the handle 20. The handle 20 may be attachable and detachable to and from the robot body 10 as described above, and may be owned by individual users. In this structure, the user may attach their own handle 20 to the robot body 10 to allow user data to be transmitted from the memory unit in the handle 20 to the robot body 10, which facilitates suitable setting of the robot for each individual user. The handle of the autonomous mobile robot according to the present invention may incorporate, for example, a structure disclosed in JP 2022-76648 A.

### REFERENCE SIGNS LIST

1 AUTONOMOUS MOBILE ROBOT
10 ROBOT BODY
11 HOUSING
12 WHEEL
13 DRIVE DEVICE
14 BATTERY
15 CONTROL DEVICE
16A ACCELERATION SENSOR
16B DISTANCE SENSOR
17 CAMERA
18 COMMUNICATION DEVICE
19 FRAME
20 HANDLE
21 SUPPORT UNIT
21 A ARM
21B ATTACHMENT PLATE
22 GRIP UNIT
22A UPPER SURFACE
22B LOWER SURFACE
22C, 22D SIDE SURFACE
23 VIBRATION ROTOR
24 FIRST OPERATION BUTTON
25 SECOND OPERATION BUTTON
30 FORCE SENSOR

1. An autonomous mobile robot for assisting a user in moving around, the autonomous mobile robot comprising:
a robot body configured to be movable in an autonomous traveling mode, in which it travels autonomously toward a destination, and a manual traveling mode, in which a traveling state can be controlled manually; and
a handle attached to the robot body,
wherein the handle includes a first operation unit for causing the robot body to travel and a second operation unit for switching a mode of the robot body,
wherein the first operation unit is provided in a first region of the handle, and
wherein the second operation unit is provided in a second region of the handle that faces in a different direction from that in which the first region faces.

2. The autonomous mobile robot according to claim 1,
wherein the handle includes a grip unit that extends in a direction in which the robot body moves, and
wherein the first operation unit and the second operation unit are provided on the grip unit.

3. The autonomous mobile robot according to claim 2, wherein the first region of the handle is an upper surface of the grip unit that faces upward in a height direction of the robot body.

4. The autonomous mobile robot according to claim 3, wherein the second region of the handle is a side surface of the grip unit.

5. The autonomous mobile robot according to claim 4,
wherein the handle includes at least one arm that extends in the height direction of the robot body,
wherein the grip unit is provided on a leading side of the at least one arm, and
wherein the second operation unit is provided at a position that overlaps the at least one arm in the height direction as viewed in a side view of the robot body.

6. The autonomous mobile robot according to claim 1, wherein the second operation unit is smaller than the first operation unit.

7. The autonomous mobile robot according to claim 1, the autonomous mobile robot further comprising a control device configured to control motion of the robot body based on an operation signal from the first operation unit and the second operation unit,
wherein, in response to operation of the second operation unit while the robot body is stopped, the control device causes the mode of the robot body to transition into the manual traveling mode.

8. The autonomous mobile robot according to claim 7, the autonomous mobile robot further comprising a sensor configured to detect a magnitude and a direction of force applied to the handle,
wherein the control device sets information for causing the robot body to travel based on detection information from the sensor.

9. The autonomous mobile robot according to claim 1,
the handle extending in a height direction of the robot body,
the autonomous mobile robot further comprising:
a sensor configured to detect a magnitude and a direction of force applied to the handle; and
a control device configured to control motion of the robot body based on detection information from the sensor,
wherein the sensor is provided at a basal portion of the handle.

10. The autonomous mobile robot according to claim 9,
wherein the handle includes at least one arm that extends in the height direction of the robot body, an attachment plate to which a basal portion of the at least one arm is fixed, and a grip unit provided on a leading side of the at least one arm, and
wherein the sensor is disposed immediately below the attachment plate.

11. The autonomous mobile robot according to claim 10,
wherein the at least one arm comprises two arms that are disposed to be spaced apart from each other in a front-and-back direction of the robot body, and
wherein the grip unit connects between the two arms.

12. The autonomous mobile robot according to claim 9, wherein the control device sets information for causing the robot body to travel based on detection information from the sensor.

13. The autonomous mobile robot according to claim 11, wherein the information for causing the robot body to travel is at least one selected from a destination of autonomous traveling and a traveling speed of the robot body.

14. The autonomous mobile robot according to claim 9, wherein the sensor is configured to be capable of detecting force acting in at least a front-and-back direction and a right-and-left direction of the robot body.
